(19) United States
(12) Patent Application Publication
(10) Pub. No.: US 2017/0178219 A1
(43) Pub. Date: Jun. 22, 2017

(54) METHODS, SYSTEMS AND COMPUTER READABLE MEDIA FOR UTILIZING PAYMENT CARD TRANSACTION DATA TO PROVIDE ALERT MESSAGES RELATING TO UNPURCHASED ITEMS TO CARDHOLDER USERS

(71) Applicant: MasterCard International Incorporated, Purchase, NY (US)

(72) Inventor: Roopa A. Vaidya, Pleasantville, NY (US)

(21) Appl. No.: 14/973,602

(22) Filed: Dec. 17, 2015

(51) Int. Cl. G06Q 30/06; G06Q 20/34

(52) U.S. Cl. CPC G06Q 30/0631; G06Q 20/34

(57) ABSTRACT

Methods, systems, and computer readable media for utilizing payment card transaction data to provide alert messages relating to unpurchased items to cardholder users are disclosed. In some aspects, the methods can include receiving a message including payment card transaction data designating one or more products or services purchased during a most recent payment card transaction conducted by a cardholder user, identifying the one or more products or services that were not purchased, but that should have been purchased, during the most recent payment card transaction, using aggregate payment card transaction data designating the one or more products or services purchased during any previous payment card transactions conducted by the cardholder user, generating an alert message identifying the one or more products or services that were not purchased, but that should have been purchased, during the most recent payment card transaction, and providing, to a cardholder user device, the alert message.

### TECHNICAL FIELD

The subject matter described herein relates to utilizing payment card transaction data to provide alert messages to cardholder users regarding one or more products and services that were not purchased during a recent payment card transaction, but should have been purchased, based on a buying pattern for that cardholder user. More particularly, the subject matter described herein relates to systems, methods, and computer readable media for utilizing payment card transaction data to provide alert messages to cardholder users relating to items that should have been purchased in a payment card transaction.

### BACKGROUND

Consumers typically need certain essential products on a periodic basis. For example, toilet paper, sugar, milk, shampoo, diapers, etc., are purchased regularly depending on consumers' needs. However, occasionally such products may be inadvertently forgotten by consumers during a shopping excursion despite being needed by those consumers. For example, a consumer may generally buy diapers every two weeks, but forgets to do so on one occasion. In this case, the consumer may have already left the store by the time he or she remembers that the diapers were forgotten. Forgetting essential products in this way may result in inefficient use of consumers' time and/or additional expense, as consumers may end up purchasing the forgotten products from different merchants that are more convenient, but more expensive.

Accordingly, there exists a need for systems, methods, and computer readable media for utilizing payment card transaction data to provide alert messages relating to unpurchased items to cardholder users.

### SUMMARY

According to one aspect, the subject matter described herein relates to, methods, systems, and computer readable media for utilizing payment card transaction data to provide alert messages relating to unpurchased items to cardholder users.

In some embodiments, methods for utilizing payment card transaction data to provide alert messages relating to unpurchased items to cardholder users may be performed at a processing server comprising at least one processor and memory. The method can include the steps of receiving, from a network, a message including payment card transaction data designating one or more products or services purchased during a most recent payment card transaction conducted by a cardholder user from a merchant entity and extracting the payment card transaction data associated with the most recent payment card transaction from the message, identifying the one or more products or services that were not purchased, but that should have been purchased, during the most recent payment card transaction by performing a lookup in a database using aggregate payment card transaction data designating the one or more products or services purchased during any previous payment card transactions conducted by the cardholder user, the aggregate payment card transaction data being stored therein, generating an alert message identifying the one or more products or services that were not purchased, but that should have been purchased, during the most recent payment card transaction, and providing, to a cardholder user device, the alert message.

In some embodiments, systems for utilizing payment card transaction data to provide alert messages relating to unpurchased items to cardholder users may include a processing server comprising at least one processor and memory and a database accessible by the processing server. The processing server may be configured to receive, from a network, a message including payment card transaction data designating one or more products and services purchased during a most recent payment card transaction conducted by a cardholder user from a merchant entity and extracting the payment card transaction data associated with the most recent payment card transaction from the message, identify the one or more products or services that were not purchased, but that should have been purchased, during the most recent payment card transaction by performing a lookup in the database using aggregate payment card transaction data designating the one or more products and services purchased during any previous payment card transactions conducted by the cardholder user, the aggregate payment card transaction data being stored therein, generate an alert message identifying the one or more products and services that were not purchased, but that should have been purchased, during the most recent payment card transaction, and provide, to a cardholder user device, the alert message.

The subject matter described herein may be implemented in hardware, software, firmware, or any combination thereof. As such, the terms “function”, “node”, “unit”, or “module” as used herein refer to hardware, which may also include software and/or firmware components, for implementing the feature being described. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary system for utilizing payment card transaction data to provide alert messages relating to unpurchased items to cardholder users according to some embodiments of the subject matter described herein;

FIG. 2 is a flow chart illustrating an exemplary process for utilizing payment card transaction data to provide alert messages relating to unpurchased items to cardholder users according to some embodiments of the subject matter described herein; and

FIG. 3 is a high level block diagram of a general purpose computer system suitable for use in utilizing payment card transaction data to provide alert messages relating to unpurchased items to cardholder users according to some embodiments of the subject matter described herein.

### DETAILED DESCRIPTION

In accordance with the subject matter disclosed herein, methods, systems, and computer readable media for utilizing payment card transaction data to provide alert messages relating to unpurchased items to cardholder users are disclosed. As used herein, payment card transaction data may include payment card transaction data (e.g., credit card transaction data and prepaid card transaction data), debit card transaction data, corporate card transaction data, and the like. The data provided by the payment card transaction data may include cardholder information (e.g., name, address, account number associated with the payment card, payment card number, a card proxy number, etc.) and transaction information or records (e.g., a total payment card transaction amount, a payment transaction date/time, a merchant entity identifier, and/or a payment transaction identifier, etc.). Additionally, the payment card transaction data may also include product and service identification (ID) data consisting of product and service ID information about individual products or services, e.g., (product name, description, Universal Product Code (UPC), Stock Keeping Unit (SKU), and/or additional product and service ID information regarding each of the one or more products and services purchased during the most recent payment card transaction). Product and service ID data may be provided, in some embodiments, by a merchant entity during a payment card transaction, or another third party. For example, another third party may consist of a market research company such as, Information Resources, Inc. (IRI).

The present subject matter may be utilized to enhance aspects of consumer shopping by providing holders of payment cards with alert messages triggered by recent payment card transactions in order to remind them to purchase and/or to inform them that they forgot to purchase any product(s) or item(s) (e.g., goods, services, commodities, etc.), prior to leaving merchant locations. In some embodiments, the present subject matter may be embodied as a website or a software application (e.g., a mobile phone application) that can be implemented and/or accessed on cardholder user devices, such as desktop computers, laptop computers, tablet computers, mobile smartphones, or the like. Notably, cardholder users may receive alert messages using these user devices and may utilize graphical user interfaces (GUIs) supported by the software application in order to modify and/or configure certain aspects of receiving alert messages regarding specific product(s). Alternatively, cardholder users may opt to receive alert messages via physical mail. A processing server in communication with cardholder user devices may be configured to utilize recent payment card transaction data, along with previously stored payment card transaction data, to generate alert messages regarding the one or more products and services that were not purchased during a most recent payment card transaction, but that should have been purchased.

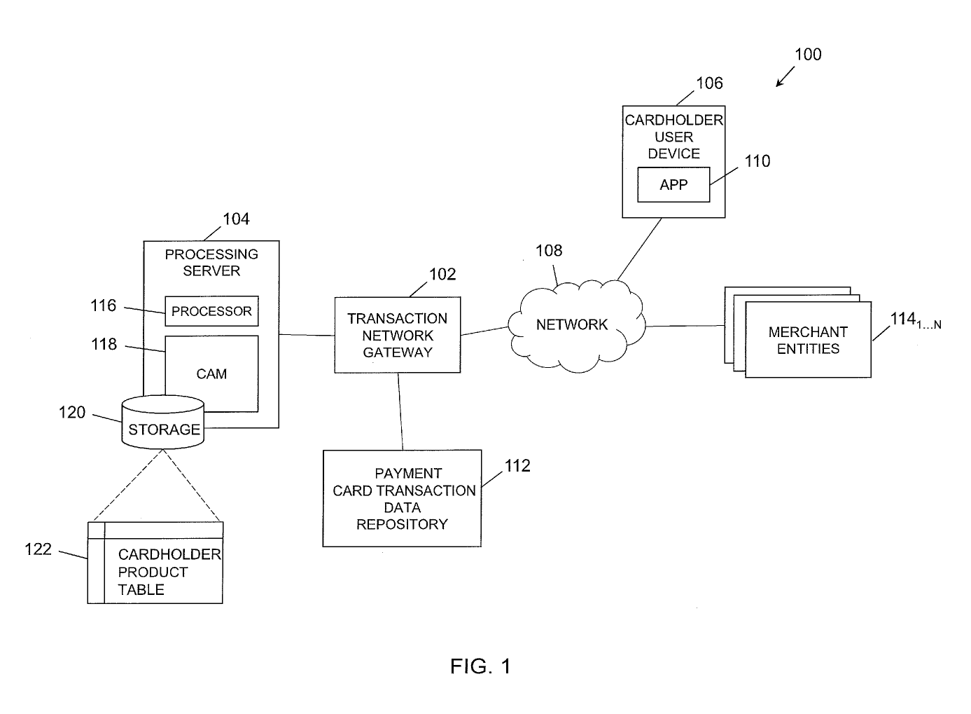

FIG. 1 illustrates an exemplary system 100 for utilizing payment card transaction data to provide alert messages relating to unpurchased items to cardholder users according to some embodiments of the subject matter described herein. For example, system 100 may include a transaction network gateway 102, a processing server 104, a cardholder user device 106, a packet-based communications network 108 (e.g., the Internet), a payment card transaction data repository 112, and a plurality of merchant entities 114_{1 . . . N}.

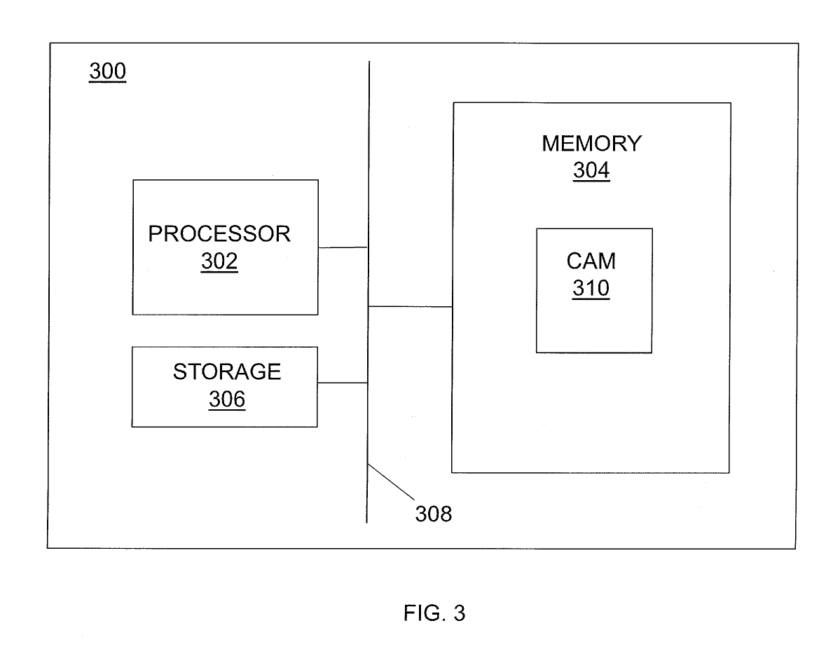

In some embodiments, processing server 104 may include a processor 116, such as a microprocessor, central processing unit (CPU), or any other like hardware based processor unit that is configured to execute and/or utilize a cardholder alert module (CAM) 118 in processing server 104. CAM 118 may be stored in local memory (see, e.g., 304, FIG. 3), such as random access memory (RAM), read only memory (ROM), optical read/write memory, cache memory, magnetic read/write memory, flash memory, and the like. CAM 118 may be configured to perform a plurality of functions. For example, CAM 118 may be configured to obtain payment card transaction data from payment card transaction data repository 112, store aggregate cardholder product data for a plurality of cardholder users in a storage device 120, configure a cardholder product table 122, store a cardholder product table 122 for each of a plurality of cardholder users in storage device 120, transmit alert messages to cardholder user device 106 regarding one or more products and services that were not purchased during a most recent payment card transaction, etc.

Processing server 104 may be communicatively connected to payment card transaction data repository 112. Although FIG. 1 depicts these network elements connected via transaction network gateway 102, processing server 104 and payment card transaction data repository 112 may be connected to each other within a payment network (e.g., communicate via intra-payment network channels), without having to communicate via transaction network gateway 102, without departing from the scope of the disclosed subject matter. In some embodiments, transaction network gateway 102 may include any gateway server, node, or unit that serves as an entry and exit point for communications (e.g., packet traffic) entering and leaving network 108 and associated infrastructure (e.g., MasterCard network infrastructure or “MasterCard network”). Transaction network gateway 102 may be communicatively connected to processing server 104, which may also be located within network 108.

Accordingly, during a purchase transaction of product(s) or service(s) a cardholder user may present and/or interface a payment card with a reader device (e.g., a magnetic stripe card reader or a smart card reader that may read data from a magnetic stripe payment card that is swiped at reader device or from an EMV chip on the smart card when the smart card is dipped in a smart card reader, and/or a wireless device reader that is configured to wirelessly read data from smart cards and/or an NFC-enabled mobile device (e.g., device 106 brought in proximity to the reader device) at merchant entities 114_{1 . . . N}. In some embodiments, each of merchant entities 114_{1 . . . N} may represent one or more computer devices or servers that are utilized by a merchant entity (e.g., a merchant company, a corporation, etc.) to record, compile, manage, process, and store payment card transaction data corresponding to payment card transactions conducted from any of the merchant entity's store or online locations. In some embodiments, a merchant entity 114 may also include a terminal device (e.g., a cash register, a credit card reader, a wireless device reader, etc.) that can be located and utilized at a particular point of sale (PoS) location associated with the merchant entity.

Regardless of the type of device, each of merchant entities 114_{1 . . . N} can be configured to supply payment card transaction data to payment card transaction data repository 112 on a periodic basis or at the discretion of a system administrator. In addition, merchant entities 114_{1 . . . N} may also be configured to provide captured UPC, SKU, and/or other product and service ID data to payment card transaction data repository 112. In some embodiments, a merchant entity 114 may utilize equipment at the POS that scans and/or captures the UPC, SKU, and/or other product and service ID data from a product or service being purchased. The UPC, SKU, and/or other product and service ID data may be initially stored in a merchant store database (not shown) associated with merchant entity 114, and subsequently provided to processing server 104 and/or payment card transaction data repository 112 via transaction network gateway 102.

Alternatively, the payment card transaction data, including the UPC, SKU, and/or other product and service ID data, may be encoded in a payment authorization request message that is forwarded to the appropriate issuer entity (e.g., a bank that issued the payment card) from merchant entities 114_{1 . . . N}. The payment card transaction data and/or credentials included in the payment authorization request message can include, for example, cardholder information (e.g., name, address, account number associated with the payment card, payment card number, a card proxy number, etc.) and transaction information or records (e.g., a total payment card transaction amount, a payment transaction date/time, a merchant entity identifier, and/or a payment transaction identifier, etc.), and product and service ID data (e.g., product name, description, UPC, SKU, and/or other product and service ID information). The payment authorization request message can typically be sent to the issuer entity via transaction network gateway 102, which may be configured to extract at least a portion of the payment card transaction data from the message, which may then be stored in payment transaction data repository 112 by processing server 104 (and/or transaction network gateway 102). Although not shown in FIG. 1, the payment authorization request message may also traverse other network elements, such as an acquirer entity server or network routing server, prior to reaching the transaction network gateway 102 or processing server 104.

As an alternative to forwarding the payment authorization request message, transaction network gateway 102 may instead be configured to extract the payment card transaction data from the payment authorization request message from merchant entities 114_{1 . . . N} and subsequently generate an indication message that includes the extracted payment card transaction data. Afterwards, transaction network gateway 102 may send the indication message containing the payment card transaction data to processing server 104. In some embodiments, each of the payment authorization request message and the indication message may comprise a web based message, such as an XML request message. However, each of the payment authorization request message and the indication message may be generated in any web based protocol, format, or specification in alternative embodiments without departing from the scope of the present subject matter.

In some embodiments, payment card transaction data repository 112 may include a computer server hosting a MasterCard payment card transaction database that records the payment card transactions conducted by MasterCard credit card, debit card, corporate card, or prepaid card users at merchant entities 114_{1 . . . N}. However, the disclosed subject matter is not limited to the use of MasterCard payment card transaction data, and thus payment card transaction data and/or consumer card transaction information from other sources may be utilized without departing from the scope of the present subject matter. In some embodiments, the payment card transaction data may be stored in payment card transaction data repository 112 as a plurality of payment card transaction data record entries. For example, each payment card transaction may be stored as a transaction data record entry and may include (and be organized by) cardholder information and/or transaction information, (e.g., a cardholder account number, a payment transaction date/time, a merchant entity identifier, a total payment transaction amount, and/or a payment transaction identifier). In some embodiments, payment card transaction data repository 112 may also be configured to comprise transaction data record entries that include one or more fields containing product and service ID data, such as UPCs, SKUs, etc. In such a case, payment card transaction data repository 112 may contain transaction data record entries, each of which comprises a payment transaction identifier that is mapped to a UPC, SKU, or other product and service ID data. In some embodiments, a plurality of UPCs, SKUs, or other product and service ID data may be grouped in a single data record entry that is associated with a common payment transaction identifier. Accordingly, payment card transaction data may readily accessible by processing server 104 and/or CAM 118 when desired (e.g., if cardholder user chooses to opt in to receive alert messages).

The payment transaction record data stored in payment card transaction data repository 112 may be stored for each payment card transaction made by a cardholder user when using a payment card. In such a case, one or more payment transaction record data entry may be stored together as aggregate cardholder product data in payment card transaction data repository 112. Alternatively, one or more payment transaction record data entry may be stored together as aggregate cardholder product data in a storage device 120, or another storage device. Regardless, aggregate cardholder product data for a single cardholder user may comprise payment transaction record data entries from one or more transactions made by the cardholder user. Depending on how many transactions have been made by the cardholder user results in a corresponding number of transactions being stored as the aggregate cardholder product data. For example, products purchased from three previous transactions made by a cardholder user using a payment card may be mapped and stored as aggregate cardholder product data in payment card transaction data repository 112, storage device 120, and/or other exemplary storage.

Storage device 120, as well as other exemplary data storage units, may include one or more external database servers that are accessible by processing server 104. Alternatively, data storage 120 may include a local database hosted by processing server 104. In some embodiments, aggregate cardholder product data for a specific cardholder may be stored in storage device 120, or another storage device, in tabular format and may be organized by, for example, a cardholder account number, a payment transaction date/time, a merchant entity identifier, a total payment transaction amount, and/or a payment transaction identifier. Aggregate cardholder product data may also include one or more fields containing product and service ID data, such as UPCs, SKUs, etc.

In some embodiments, CAM 118 and/or processing server 104 may be configured to analyze the aggregate cardholder product data stored in storage device 120. CAM 118 may be configured to identify frequently bought products based on an analysis of the aggregate cardholder product data stored in storage device 120 over a period of time by looking up how often a product is purchased in a given time period in storage device 120. For example, essential products (e.g., toilet paper) may be more frequently bought than less essential, luxury, seasonal, etc., products (e.g., suntan lotion, Christmas decorations, jewelry) during a preconfigured period of time. The period of time may be configured by a third-party administrator or manager associated with the payment card. For example, a third-party administrator associated with MasterCard may configure an optimal period of time for identifying frequently bought products. The period of time can be, for example, at least one year, three years, etc. CAM 118 may also be configured to determine buying patterns for an individual cardholder user over a period of time based on an analysis of the aggregate cardholder product data stored in storage device 120. For example, where one package of diapers is purchased by a cardholder user on a weekly basis, CAM 118 may be configured to determine that the cardholder user has a buying pattern of one package of diapers per week for the past three years.

Notably, the aggregate cardholder product data is dynamic for each cardholder user since it may be updated upon each payment card transaction conducted by the individual payment card user when using the payment card. Thus, CAM 118 may be configured to recognize any changes in frequency of purchase of certain products, and thereby adjust any recognized buying pattern for that product to reflect the change in frequency. For example, if a cardholder user is buying suntan lotion twice a month during the summer months and suddenly stops purchasing suntan lotion in the fall, CAM 118 may be configured to identify the frequency of purchase of the suntan lotion during the summer months and recognize a decrease in frequency of purchase during the fall months, and can subsequently adjust the buying pattern for suntan lotion to reflect the cardholder user's frequency of purchase.

In some embodiments, processing server 104 may be configured to combine the aggregate cardholder product data stored in storage device 120 and leverage the identified frequently bought products and/or buying patterns for those products in order to create a data structure for storing not only the aggregate cardholder product data, but also the identified frequently bought products and/or buying patterns for those products for a single cardholder user. For example, the data structure may comprise a cardholder product table 122 with data fields containing the aggregate cardholder product data and identified frequently bought products and/or buying patterns for those products for a single cardholder user. In this example, the data may be stored in tabular form as payment card transaction data record entries. Data stored in the cardholder product table 122 may include, for example, cardholder account number, a payment transaction date/time, a merchant entity identifier, a total payment transaction amount, and/or a payment transaction identifier, frequency of purchase for purchased products, and buying patterns for purchased products. Each cardholder user may have his or her own unique cardholder product data table stored at storage device 120 and/or other storage entity.

Additionally, where there is a recorded buying pattern for a particular product for that cardholder user, cardholder product table 122 may include an alert message field set with a time period at which the product is due to be purchased again. Over time, in some embodiments, the buying pattern and thereby the alert message, may be adjusted for that particular product. Any products for a specific cardholder user that comprise an identified buying pattern may each contain a separate alert message data field entry based off of that buying pattern.

In order to determine whether an alert message should be transmitted to the cardholder user, processing server 104 and/or CAM 118 can be configured to update data fields of cardholder product table 122 using recent payment card transactions; namely, updating cardholder product table 122 concerns updating a time period data entry in an alert message data field for each product having an identified buying pattern. Updating may also include adjusting and/or modifying buying patterns for a specific product(s).

In some embodiments, cardholder product table 122 may be dynamically updated via automatic forwarding of recent payment card transaction data record entries in payment card transaction data repository 112 to cardholder product table 122. For example, payment card transaction data repository 112 may be configured to automatically forward to cardholder product table 122 only those payment card transaction data record entries with payment transaction dates/times occurring after a most recent automatic transmittal of payment card transaction data record entries. In other embodiments, cardholder product table 122 may be dynamically updated via processing server 104 and/or CAM 118 searching through the recent payment card transaction data record entries in payment card transaction data repository 112. For example, processing server 104 and/or CAM 118 may utilize a payment transaction dates/times search to query and/or access only those payment card transaction data record entries with payment transaction dates/times occurring after the most recent transmittal of payment card transaction data record entries from payment card transaction data repository 112 to cardholder product table 122. Once processing server 104 and/or CAM 118 have accessed the most recent payment card transaction data record entries, cardholder product table 122 may be updated.

Regardless, updating cardholder product table 122 may result in processing server 104 and/or CAM 118 analyzing cardholder product table 122 to determine which alert messages are due to be sent to the cardholder user. For example, CAM 118 may be configured to apply a dynamic filter to cardholder product table 122. The filter can comprise a dynamic filter window that captures a period of time from a date of the most recent payment card transaction and a preconfigured number of days after the date of the most recent payment card transaction. For example, a user can preconfigure the filter window as being seven days after a most recent payment card transaction. Thus, where a cardholder user has preconfigured a dynamic filter, the filter can capture any product(s) or service(s) that have a time period for transmittal of an alert message within the filter window. For example, if the cardholder user has preconfigured a filter with a seven day filter window, and eggs are due to be purchased within six days, eggs will be captured by the dynamic filter. Accordingly, processing server 104 and/or CAM 118 may be configured to identify or determine all of the product(s) or service(s) that satisfy the filter requirements by performing a lookup of how many products fail to satisfy the filter requirements in cardholder product table 122.

After identifying all of the product(s) or service(s) that satisfy the filter requirements (e.g., product(s) or service(s) that have a time period for transmittal of an alert message within the filter window), processing server 104 and/or CAM 118 may be configured to generate an alert message for transmittal to cardholder user device 106. In some embodiments, processing server 104 may transmit the alert message to cardholder user device 106 via network 108 (e.g., an IP network and/or a cellular network) using web services XML. In some embodiments, processing server 104 may transmit the generated listing to cardholder user device 106, which may utilize a GUI to display the alert message to a cardholder user. In particular, cardholder user device 106 may be configured to receive an alert message transmitted through packet-based network 108 and containing a listing of all identified product(s) or service(s) that satisfied the filter requirements and should have been purchased during the most recent payment card transaction, but that were not purchased. Cardholder user device 106 may also be configured to extract the listing of all identified product(s) or service(s) that satisfied the filter requirements and should have been purchased during the most recent payment card transaction, but that were not purchased. In some embodiments, the alert message can be in text format and can include the text: “[CARDHOLDER USER'S NAME], you forgot to buy [ALL PRODUCT(S) IDENTIFIED AS SATISFYING THE FILTER REQUIREMENTS]. Are you stocked up on [ALL PRODUCT(S) IDENTIFIED AS SATISFYING THE FILTER REQUIREMENTS]?” Other text and/or graphical alert messages may be used, as well.

In some embodiments, cardholder user device 106 may be configured with one or more functions that enable a cardholder user to receive the alert messages. For example, cardholder user device 106 may include a mobile device comprising a mobile application (e.g., a mobile app 110). Alternatively, cardholder user device 106 (e.g., either a mobile device or a personal computer) may include access to a website (e.g., supported by processing server 104 and/or CAM 118). Additionally, processing server 104 and/or CAM 118 may be configured to transmit alert messages to third-party sponsors, such as banking institutions and external vendors (e.g., Target), for forwarding alert messages to cardholder users independently, as well as promoting mobile app 110.

In some embodiments, cardholder device 106 may include a GUI that is configured to receive direct input from a cardholder user for management and configuration of alert messages. For example, the GUI may enable a cardholder user to directly interact with mobile app 110 and/or a website configuration page (not shown) to opt in or opt out of receiving alert messages, determine a mode of alert message(s), configure a dynamic filter, determine any delay(s) in receiving alert message(s), determine frequency of receiving alert message(s), etc. The GUI may be configured to allow a cardholder user to access mobile app 110 and/or a website configuration page to interactively choose to opt in to receiving alert messages, although in some instances, alert messages may not be forwarded to the cardholder user until a period of time since the cardholder user has opened an account associated with the payment card has passed. For example, where a buying pattern for a cardholder user is only determined after a preconfigured time period (e.g., a full year after opening an account associated with the payment card), the cardholder user may not be able to receive alert messages until a full year has passed. Shorter or longer periods of time, such as one month, six months, four years, etc., may be configured by a manager or other third-party administrator. However, in this manner, buying patterns may be more accurately established with longer, preconfigured periods of time, such that the alert messages transmitted to the cardholder user are not superfluous (i.e., they do not accurately reflect the buying patterns of the cardholder user because insufficient data has been gathered). Conversely, the cardholder user may choose at any time to opt out of receiving alert messages by accessing mobile app 110 and/or a website configuration page on device 106. Regardless of whether the cardholder user has opted in or opted out, however, payment card transaction data may still be collected and stored in payment card transaction data repository 112, cardholder product table 122 may still be updated, and/or buying patterns may still be identified.

The GUI of cardholder device 106 may also be configured to allow a cardholder user to access mobile app 110 and/or a website configuration page to interactively designate a mode for receiving the alert messages. For example, voicemail, text message, email, and even physical mail, may be designated by the cardholder user as the desired mode for receiving alert message(s). One or more modes may be designated by the cardholder user. Where the cardholder user has selected one or more electronic mode (i.e., voicemail, text message, email and/or physical mail) the cardholder user may input one or more designated phone number and/or email address to which alert messages may be transmitted.

The GUI of cardholder device 106 may also be configured to allow a cardholder user to access mobile app 110 and/or a website configuration page to interactively configure a dynamic filter. As discussed herein, the dynamic filter can be configured to capture any product(s) or service(s) that have a time period for transmittal of an alert message within the filter window. In some embodiments, the cardholder user may configure a filter window of the dynamic filter based off of how often he or she frequents a merchant entity location (whether physical or online) for regular shopping. For example, where the cardholder user frequents a grocery store for general shopping once a week, a cardholder user may decide to preconfigure a filter window of the dynamic filter as seven days. Thus, in this example, an alert message may be transmitted to the cardholder user after a weekly shopping trip and alert the cardholder user of product(s) or service(s) that have seven or less days until their time window expires (i.e., those products are ready for repurchase). In this way, the cardholder user can return to the store, while he or she is still there, and purchase any products that were forgotten.

In some embodiments, the GUI of cardholder user device 106 may be configured to allow a cardholder user to access mobile app 110 and/or a website configuration page to interactively determine whether or not alert messages are transmitted in real time. For example, the GUI may be configured to allow a cardholder user to access mobile app 110 and/or a website configuration page and interactively decide whether or not to receive alert messages transmitted in real time or substantially simultaneously after a recent payment card transaction has been made. As defined herein, ‘real time’ can refer to a length of time it takes between a payment card transaction being authorized and the cardholder product table being analyzed by processing server 104 and/or CAM 118 to identify which, if any products or services, meet the preconfigured filter requirements. Conversely, if the cardholder user decides to not receive alert messages transmitted in real time, the GUI may be configured to allow a cardholder user to access mobile app 110 and/or a website configuration page to interactively opt to receive alert messages based on a designated frequency. For example, the cardholder user may choose to receive alert messages one day after a payment card transaction. In that case, an alert message containing a list of any product(s) or service(s) that meet preconfigured filter requirements will be transmitted to the cardholder user one day after the last payment card transaction. The designated frequency may be configured and/or modified at any point by the cardholder user.

Upon receiving any cardholder user configuration and/or modification, processing server 104 may be configured to extract cardholder user configuration and/or modification information in order to utilize such information when transmitting alert messages to that specific cardholder user, as previously described.

It will be appreciated that FIG. 1 is for illustrative purposes and that the configuration of system 100 and each element described therein in terms of structure, location, and/or function may be changed, altered, added, or removed. For example, some elements and/or functions may be removed and/or combined into a single entity.

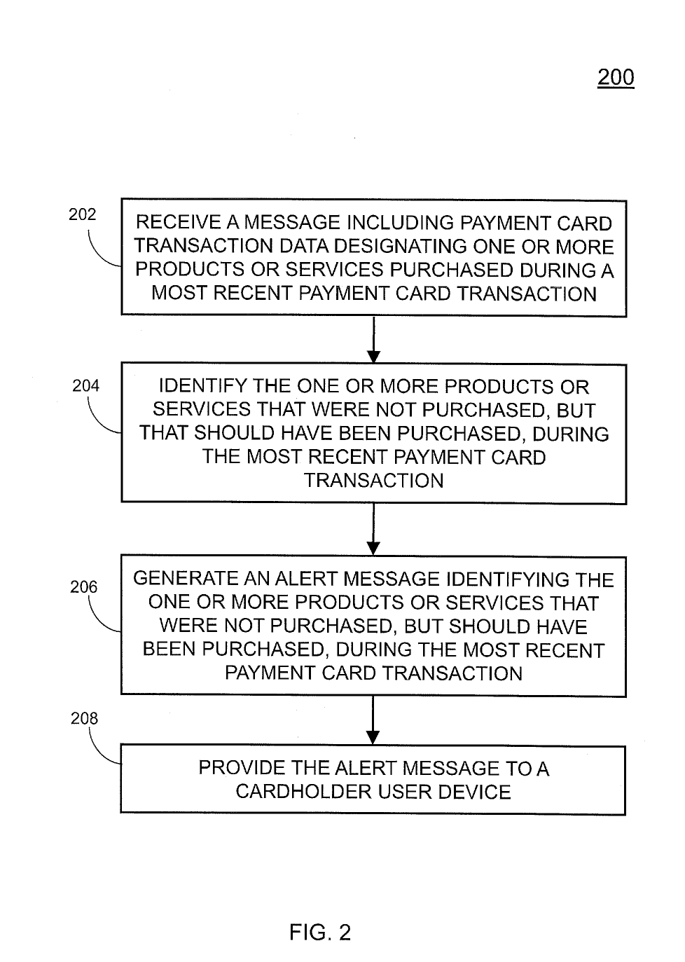

FIG. 2 is a flow chart illustrating an exemplary method 200 for utilizing payment card transaction data to provide alert messages relating to unpurchased items to cardholder users according to some embodiments of the subject matter described herein. Although exemplary method 200 utilizes payment card transaction data, any type of payment card transaction data may be utilized without departing from the scope of the present subject matter.

In step 202, a message including payment card transaction data designating one or more products and services purchased during a most recent payment card transaction conducted by a cardholder user from a merchant entity may be received from a packet-based network (e.g., 108, FIG. 1) and may be extracted by a processing server (e.g., 104, FIG. 1) and/or a cardholder alert module (e.g., CAM 118, FIG. 1). In some embodiments, a cardholder user may conduct a payment card transaction at a merchant entity location 114, where the merchant entity 114 is configured to transmit payment card transaction data to a payment card transaction data repository 112.

In some embodiments, payment card transaction data may comprise a payment card account number, a total amount of the most recent payment card transaction, a date and/or time of the most recent payment card transaction, an identifier of the merchant entity, an identifier of the most recent payment card transaction, and product and service ID information about each of the one or more products and services purchased during the most recent payment card transaction. In particular, the product and service ID information about each of the one or more products and services purchased during the most recent payment card transaction may include UPC, SKU and/or additional ID information regarding each of the one or more products and services purchased during the most recent payment card transaction. In some embodiments, merchant entity 114 may be configured with capability for capturing product and service ID data and providing it to payment card transaction data repository 112.

In step 204, the one or more products and services that were not purchased, but that should have been purchased, during the most recent payment card transaction may be identified by performing a lookup in a database using aggregate payment card transaction data designating the one or more products and services purchased during any previous payment card transactions conducted by the cardholder user. In some embodiments, the aggregate payment card transaction data may be stored in the database.

In some embodiments, the aggregate payment card transaction data stored in the database may be updated with the payment card transaction data designating the one or more products and services purchased during the most recent payment card transaction. In some embodiments, the aggregate payment card transaction data may be analyzed to determine a frequency, a buying pattern, and/or an alert message time period of each of the one or more products and services designated by the aggregate payment card transaction data. In some embodiments, a filter may be applied to the aggregate payment card transaction data stored in the database. For example, the filter may comprise a dynamic filter window that may be configured to capture a period of time from a date of the most recent payment card transaction and a preconfigured number of days after the date of the most recent payment card transaction, such that the filter is configured to identify, as a product or service that should have been purchased, any of the one or more products and services designated by the aggregate payment card transaction data that have an alert message time period within the dynamic filter window.

In step 206, an alert message including the one or more products and services that were not purchased, but that should have been purchased, during the most recent payment card transaction may be generated.

In some embodiments, the alert message may be generated and may include product and service ID information regarding each of the one or more products and services having an alert message time period within the dynamic filter window.

In step 208, the alert message may be provided to a cardholder user device (e.g., 106, FIG. 1). In some embodiments, the alert message may be provided to the cardholder user device either substantially immediately or after a pre-determined delay configured by the cardholder user in response to the most recent payment card transaction.

FIG. 3 depicts a high level block diagram of a general purpose computer system suitable for use in utilizing payment card transaction data to provide alert messages relating to unpurchased items to cardholder users according to some embodiments. As depicted in FIG. 3, a system 300 may be similar to a processing server, such as processing server 104, and may comprise a processor 302, a memory 304, and a storage device 306, which is communicatively connected via a system bus 308. Processor 302 can comprise a microprocessor, central processing unit (CPU), or any other like hardware based processing unit, similar to processor 116 described in reference to FIG. 1. In some embodiments, a CAM 310 can be stored in memory 304, which can comprise random access memory (RAM), read only memory (ROM), optical read/write memory, cache memory, magnetic read/write memory, flash memory, or any other non-transitory computer readable medium. CAM 310 may, in some embodiments, contain similar functionality to CAM 118, described in FIG. 1. In some embodiments, processor 302 and memory 304 can be used to execute and manage the operation of CAM 310. In some embodiments, storage device 306 can comprise any storage medium or storage unit that is configured to store data accessible by processor 302 via system bus 308. For example, storage device 306 can comprise storage 120 as described in FIG. 1. Exemplary storage devices can comprise one or more local databases hosted by system 300.

Thus, when configured as described herein, system 300 becomes a special purpose computing platform that can improve the technological field of utilizing payment card transaction data to provide alert messages relating to unpurchased items to cardholder users regarding cardholder user products that were not purchased during a recent payment card transaction, but should have been purchased, based on a buying pattern for that cardholder user. Specifically, coordination between system 300 and a cardholder user device (e.g., 106, FIG. 1) is necessarily rooted in computer technology in order to overcome a problem specifically arising in the realm of computer networks (i.e., transmitting, from a computing platform to a cardholder user device, alert messages for forgotten product(s) before the cardholder user exits a merchant location).

It will be understood that various details of the subject matter described herein may be changed without departing from the scope of the subject matter described herein. Furthermore, the foregoing description is for the purpose of illustration only, and not for the purpose of limitation.

What is claimed is:

1. A method for utilizing payment card transaction data to provide alert messages relating to unpurchased items to cardholder users, the method comprising:
at a processing server comprising at least one processor and memory:
receiving, from a network, a message including payment card transaction data designating one or more products or services purchased during a most recent payment card transaction conducted by a cardholder user from a merchant entity and extracting the payment card transaction data associated with the most recent payment card transaction from the message;
identifying the one or more products or services that were not purchased, but that should have been purchased, during the most recent payment card transaction by performing a lookup in a database using aggregate payment card transaction data designating the one or more products or services purchased during any previous payment card transactions conducted by the cardholder user, the aggregate payment card transaction data being stored therein;
generating an alert message identifying the one or more products or services that were not purchased, but that should have been purchased, during the most recent payment card transaction; and
providing, to a cardholder user device, the alert message.

2. The method of claim 1, wherein receiving the message including the payment card transaction data designating the one or more products or services purchased during the most recent payment card transaction includes receiving a message including at least one of: a payment card account number, a total amount of the most recent payment card transaction, a date and/or time of the most recent payment card transaction, an identifier of the merchant entity, an identifier of the most recent payment card transaction, and product or service identification (ID) information about each of the one or more products or services purchased during the most recent payment card transaction.

3. The method of claim 2, wherein the product or service ID information includes a Universal Product Code (UPC), a Stock Keeping Unit (SKU), and/or additional product or service ID information regarding each of the one or more products or services purchased during the most recent payment card transaction.

4. The method of claim 1, wherein the message including the payment card transaction data designating the one or more products or services purchased during the most recent payment card transaction is received from a payment card transaction data repository storing the payment card transaction data designating the one or more products or services purchased during the most recent payment card transaction therein.

5. The method of claim 1, further comprising updating the aggregate payment card transaction data stored in the database with the payment card transaction data designating the one or more products and services purchased during the most recent payment card transaction.

6. The method of claim 5, further comprising analyzing the aggregate payment card transaction data to determine a frequency, a buying pattern, and/or an alert message time period of each of the one or more products and services designated by the aggregate payment card transaction data.

7. The method of claim 6, wherein identifying the one or more products and services that were not purchased, but that should have been purchased, during the most recent payment card transaction comprises applying a filter to the aggregate payment card transaction data stored in the database, the filter including a dynamic filter window that captures a period of time from a date of the most recent payment card transaction and a preconfigured number of days after the date of the most recent payment card transaction, such that the filter is configured to identify, as a product or service that should have been purchased, any of the one or more products or services designated by the aggregate payment card transaction data that have an alert message time period within the dynamic filter window.

8. The method of claim 7, wherein generating the alert message identifying the one or more products and services that were not purchased, but that should have been purchased, during the most recent payment card transaction comprises generating the alert message including product or service identification (ID) information regarding each of the one or more products and services having an alert message time period within the dynamic filter window.

9. The method of claim 1, wherein providing the alert message includes providing the alert message either substantially immediately or after a pre-determined delay configured by the cardholder user in response to the most recent payment card transaction.

10. A system for utilizing payment card transaction data to provide alert messages relating to unpurchased items to cardholder users, the system comprising:
a processing server comprising at least one processor and memory; and
a database accessible by the processing server;
wherein the processing server is configured to:
receive, from a network, a message including payment card transaction data designating one or more products and services purchased during a most recent payment card transaction conducted by a cardholder user from a merchant entity and extracting the payment card transaction data associated with the most recent payment card transaction from the message,
identify the one or more products or services that were not purchased, but that should have been purchased, during the most recent payment card transaction by performing a lookup in the database using aggregate payment card transaction data designating the one or more products and services purchased during any previous payment card transactions conducted by the cardholder user, the aggregate payment card transaction data being stored therein,
generate an alert message identifying the one or more products and services that were not purchased, but that should have been purchased, during the most recent payment card transaction, and
provide, to a cardholder user device, the alert message.

11. The system of claim 10, wherein the processing server is further configured to receive a message including at least one of: a payment card account number, a total amount of the most recent payment card transaction, a date and/or time of the most recent payment card transaction, an identifier of the merchant entity, an identifier of the most recent payment card transaction, and product or service identification (ID) information about each of the one or more products and services purchased during the most recent payment card transaction.

12. The system of claim 11, wherein the product or service ID information includes a Universal Product Code (UPC), a Stock Keeping Unit (SKU), and/or additional product or service ID information regarding each of the one or more products and services purchased during the most recent payment card transaction.

13. The system of claim 10, further comprising a payment card transaction data repository configured to store and transmit, across the network, the message including the payment card transaction data designating the one or more products and services purchased during the most recent payment card transaction.

14. The system of claim 10, wherein the processing server is further configured to update the aggregate payment card transaction data stored in the database with the payment card transaction data designating the one or more products and services purchased during the most recent payment card transaction.

15. The system of claim 14, wherein the processing server is further configured to analyze the aggregate payment card transaction data to determine a frequency, a buying pattern, and/or an alert message time period of each of the one or more products and services designated by the aggregate payment card transaction data.

16. The system of claim 15, wherein the processing server is further configured to apply a filter to the aggregate payment card transaction data stored in the database, the filter including a dynamic filter window that captures a period of time from a date of the most recent payment card transaction and a preconfigured number of days after the date of the most recent payment card transaction, such that the filter is configured to identify, as a product or service that should have been purchased, any of the one or more products and services designated by the aggregate payment card transaction data that have an alert message time period within the dynamic filter window.

17. The system of claim 16, wherein the processing server is further configured to generate the alert message identifying product or service identification (ID) information regarding each of the one or more products and services having an alert message time period within the dynamic filter window.

18. The system of claim 17, wherein the processing server is configured to provide, to the cardholder user device, the alert message either substantially immediately or after a pre-determined delay configured by the cardholder user in response to the most recent payment card transaction.

19. A non-transitory computer readable medium having stored thereon executable instructions which, when executed by a processor of a computer, cause the computer to perform steps comprising:
receiving, from a network, a message including payment card transaction data designating one or more products or services purchased during a most recent payment card transaction conducted by a cardholder user from a merchant entity and extracting the payment card transaction data associated with the most recent payment card transaction from the message;
identifying the one or more products or services that were not purchased, but that should have been purchased, during the most recent payment card transaction by performing a lookup in a database using aggregate payment card transaction data designating the one or more products or services purchased during any previous payment card transactions conducted by the cardholder user, the aggregate payment card transaction data being stored therein;
generating an alert message identifying the one or more products or services that were not purchased, but that should have been purchased, during the most recent payment card transaction; and
providing, to a cardholder user device, the alert message.

20. The computer readable medium of claim 19, further comprising updating the aggregate payment card transaction data stored in the database with the payment card transaction data designating the one or more products and services purchased during the most recent payment card transaction.
